(19) United States
(12) Patent Application Publication
(10) Pub. No.: US 2023/0388470 A1
(43) Pub. Date: Nov. 30, 2023

(54) NEURAL NETWORK TRAINING FOR IMPLICIT RENDERING

(71) Applicant: Soul Vision Creations Private Limited, Bengaluru (IN)

(72) Inventors: Sravanth Aluru, Bengaluru (IN); Gaurav Baid, Bengaluru (IN); Shubham Jain, Bengaluru (IN); Anuvesh Kumar, Bengaluru (IN)

(21) Appl. No.: 18/324,579

(22) Filed: May 26, 2023

(30) Foreign Application Priority Data
May 31, 2022 (IN) 202241031279

(51) Int. Cl. H04N 13/117; H04N 13/388; G06T 17/00; G06V 10/25; G06V 10/74; G06V 10/82

(52) U.S. Cl. CPC H04N 13/117; H04N 13/388; G06T 17/00; G06V 10/25; G06V 10/761; G06V 10/82

(57) ABSTRACT

A system includes a storage system configured to store a plurality of images from a plurality of viewpoints in a scene, and processing circuitry coupled to the storage system. The processing circuitry is configured to: generate a point cloud of the scene based on the plurality of images; determine samples on a ray from a viewpoint of the plurality of viewpoints based on the point cloud; and train a neural network based on the determined samples on the ray to generate a trained model, the trained model being configured to generate image content of the scene from a viewpoint different than the plurality of viewpoints.

This application claims the benefit of Indian Provisional Patent Application 202241031279 filed on May 31, 2022, the entire content of which is hereby incorporated by reference.

### TECHNICAL FIELD

The disclosure relates to graphics rendering.

### BACKGROUND

Neural Radiance Field (NeRF) is a machine learning based technique, where a neural network is trained from a sparse set of input views for image content (e.g., a scene). In NeRF, the input to the trained neural network is a position and a direction, and the output of the trained neural network is a color value and density value (e.g., opacity) of the image content for the input position and direction. In this way, processing circuitry may utilize the trained neural network to determine the color values and density values from different positions, and render the image content using the determined color values and density values.

### SUMMARY

In general, the disclosure describes example techniques for neural network training for implicit rendering. The example techniques may include mask cache techniques to speed up neural network training, such as for Neural Radiance Field (NeRF). The example techniques may also reduce shape-radiance ambiguity.

As described in more detail, the disclosure describes example techniques of utilizing a point cloud of one or more objects in a scene to train a neural network such as for NeRF. For training the neural network, processing circuitry may determine samples along a ray from a viewpoint (e.g., a ray extending from a virtual camera), and input these samples (e.g., 3D coordinates and color values) into the neural network. Processing circuitry may utilize the points of the point cloud to determine which samples along the ray should be input into the neural network for training. In this manner, the example techniques may reduce the number of samples that are input to the neural network, which can speed up neural network training.

Also, because the point cloud for the one or more objects provides a representation of the structure of the one or more objects, the neural network may be trained in such a way to reduce shape-radiance ambiguity. For instance, due to shiny reflections, as an example, a trained model may incorrectly determine that the reflection is a color change within the object, and is part of the object, instead of determining the reflection is actually not part of the object. By using the point cloud, which provides a rough estimate of the structure of the objects, the trained model may more accurately reconstruct image content for the one or more objects. That is, the trained model may generate image content for the reflection image content and the object image content more accurately, as compared to other techniques which may generate object image content that conflates with the reflection image content.

In one example, the disclosure describes a system comprising: a storage system configured to store a plurality of images from a plurality of viewpoints in a scene; and processing circuitry coupled to the storage system and configured to: generate a point cloud of the scene based on the plurality of images; determine samples on a ray from a viewpoint of the plurality of viewpoints based on the point cloud; and train a neural network based on the determined samples on the ray to generate a trained model, the trained model being configured to generate image content of the scene from a viewpoint different than the plurality of viewpoints.

In one example, the disclosure describes a method comprising: generating a point cloud of a scene based on a plurality of images from a plurality of viewpoints in the scene; determining samples on a ray from a viewpoint of the plurality of viewpoints based on the point cloud; and training a neural network based on the determined samples on the ray to generate a trained model, the trained model being configured to generate image content of the scene from a viewpoint different than the plurality of viewpoints.

In one example, the disclosure describes computer-readable storage media comprising instructions that when executed by one or more processors cause the one or more processors to: generate a point cloud of a scene based on a plurality of images from a plurality of viewpoints in the scene; determine samples on a ray from a viewpoint of the plurality of viewpoints based on the point cloud; and train a neural network based on the determined samples on the ray to generate a trained model, the trained model being configured to generate image content of the scene from a viewpoint different than the plurality of viewpoints.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating a system in accordance with one or more examples described in this disclosure.

FIG. 2 is a block diagram illustrating one or more servers of FIG. 1 in greater detail.

FIG. 3 is a block diagram illustrating an example of a personal computing device configured to perform one or more example techniques described in this disclosure.

FIG. 4 is a conceptual diagram of a point cloud.

FIG. 5 is a conceptual diagram of a mask cache indicative of occupancy of a voxel in a grid.

FIG. 6 is a flowchart illustrating an example method of training a neural network for Neural Radiance Field (NeRF).

### DETAILED DESCRIPTION

Content creators for three-dimensional graphical content, such as for extended reality (XR) such as virtual reality (VR), mixed reality (MR), augmented reality (AR), etc. tend to define a three-dimensional object as an interconnection of plurality of polygons. However, generating content in this manner tends to be time, labor, and computationally intensive.

Implicit rendering techniques include a relatively recent manner of creating and rendering three-dimensional graphical content. In implicit rendering, the image content of an object is defined by mathematical functions and equations (e.g., continuous mathematical functions and equations). The continuous mathematical functions and equations are generated from machine learning techniques. For instance, a trained neural network forms the continuous mathematical functions and equations that define the image content of an object. One example technique of implicit rendering is the Neural Radiance Field (NeRF) technique.

For training the neural network, one or more servers may receive a plurality of two-dimensional images, which tend to be easier to define than a three-dimensional object. The one or more servers train the neural network using the plurality of two-dimensional images as the training dataset for training the neural network. The one or more servers also use the plurality of two-dimensional images to confirm the validity of the trained neural network.

For instance, the images may be captured from a plurality of respective viewpoints in a scene. The images that form the training images used to train the neural network may be a set of image from fewer than all viewpoints. Because the training images are from different viewpoints, each of the images is a two-dimensional representation of the three-dimensional space from a different location, and the images together define the three-dimensional space.

Processing circuitry may output a ray in the three-dimensional space, and determine samples (e.g., pose information of samples) along the ray. The pose information may be the direction (x, y, z coordinates and direction coordinates). The processing circuitry inputs the pose information of the samples into the neural network, and the neural network determines color (e.g., RGB) and density information for the samples. That is, the processing circuitry may input the samples from the ray to the neural network, and apply weights and biases of the neural network to the samples to generate a two-dimensional representation of the scene from the viewpoint associated with the ray. For example, the processing circuitry may apply volumetric rendering to generate the two-dimensional representation.

The processing circuitry may compare the two-dimensional representation to the image for the viewpoint. That is, the two-dimensional representation may be an estimate (e.g., inference) of what the image content is from a particular viewpoint. However, there may be a captured image from the viewpoint that forms as the ground truth. For instance, the training images are the ground truth against which the processing circuitry compares two-dimensional representations generated by the neural network for training. The processing circuitry may update the weights or biases of the neural network based on the comparison to generate the trained model.

For NeRF, the processing circuitry may overfit the neural network. That is, unlike other neural networks that are designed to generate trained models applicable to different data, the trained model for NeRF is a trained model that is specific to the scene, and can generate image content of the scene for viewpoints for which there is no captured image content. The trained model may not be applicable to another scene.

As described above, the samples (e.g., pose information of samples) of a ray are input to the neural network for training. In some examples, the rate at which the processing circuitry can generate the trained model may be based on the number of samples of a ray that are input. There may be a desire to train the neural network quickly to generate the trained model so that the trained model can provide image content from different views. However, simply reducing the number of samples that are used for training the neural network to increase the speed of training (e.g., reduce training time) may result is sub-optimal trained models.

This disclosure describes example techniques to reduce the number of samples that need to be input for training the neural network, while ensuring that the trained model is robust and accurately generates image content. For instance, in some cases, many samples along the ray are empty (e.g., provide no color or opacity information) and do not contribute to the training, but are still sampled to ensure that samples that do contribute to the training are not skipped.

In accordance with one or more examples described in this disclosure, the processing circuitry may generate a point cloud for the scene (e.g., for one or more objects in the scene). For example, the point cloud may be a discrete set of points that represent a three-dimensional shape. Each point in the point cloud may have an associated coordinate and an associated color. However, it is not required for points in the point cloud to have a color.

The processing circuitry may determine samples on a ray from a viewpoint of the plurality of viewpoints based on the point cloud. For instance, the processing circuitry may use the point cloud as a way to determine occupancy of samples on a ray. The occupancy of samples on the ray may mean information that indicates whether a sample on the ray intersects the one or more objects in the scene. In some examples, the occupancy may indicate that the sample is close to the one or more objects in the scene. The processing circuitry may use as input, for training the neural network, samples on the ray that intersect the one or more objects in the scene or are relatively close to the one or more objects in the scene. In this manner, the processing circuitry may reduce the number of samples that are input for training.

Furthermore, the use of point clouds for determining which samples to use as input for training may provide additional benefits. As one example, the trained model may suffer from shape radiance ambiguity. For instance, in an input image used as ground truth, there may be reflections or light shining. For training, the neural network may not correctly differentiate whether pixels associated with the reflections or shining are part of the object or not part of the object. That is, the radiance from the reflection or shining light may be considered by the neural network as pixels of the object.

The point cloud represents the three-dimensional shape of the one or more objects. For instance, the point cloud may represent a three-dimensional structure of the one or more objects. Therefore, the samples on a ray that are used for training may be the actual samples of the one or more objects, and not pixels representing radiance. In this way, the trained model may be better able to differentiate between radiance reflecting off of the object and the contours of the object.

In one or more examples, the trained model may be a volumetric scene function that can directly generate an appearance of the scene. For instance, as described above, the trained model may be used in implicit rendering in which an object is defined by mathematical functions and equations (e.g., continuous mathematical functions and equations). To render the image content of a viewpoint, other than the plurality of viewpoints for which images are available, the trained model may use volumetric rendering techniques. For instance, for training, the processing circuitry may use rays for determining which samples to input. Then, once trained, the processing circuitry may again generate rays, but from the viewpoint for which image content needs to be generated.

The processing circuitry may determine whether samples on the ray are inside or outside of the one or more objects based on the mathematical functions and equations, and then integrate over the samples on the ray to generate a color value. The processing circuitry may repeat these operations to generate the image content from the desired viewpoint.

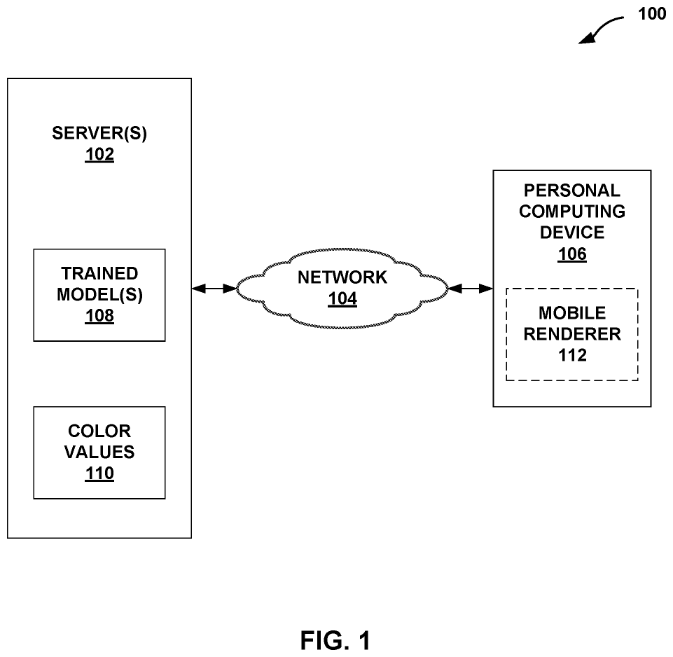

FIG. 1 is a block diagram illustrating a system in accordance with one or more examples described in this disclosure. As illustrated, system 100 includes one or more servers 102, network 104, and personal computing device 106.

Examples of personal computing device 106 include mobile computing devices (e.g., tablets or smartphones), laptop or desktop computers, e-book readers, digital cameras, video gaming devices, and the like. In some examples, personal computing device 106 may be a headset such as for viewing extended reality content, such as virtual reality, augmented reality, and mixed reality. For example, a user may place personal computing device 106 close to his or her eyes, and as the user moves his or her head, the content that the user is viewing will change to reflect the direction in which the user is viewing the content.

In some examples, servers 102 are within a cloud computing environment, but the example techniques are not so limited. Cloud computing environment represents a cloud infrastructure that supports multiple servers 102 on which applications or operations requested by one or more users run. For example, the cloud computing environment provides cloud computing for using servers 102, hosted on network 104, to store, manage, and process data, rather than at personal computing device 106.

Network 104 may transport data between servers 102 and personal computing device 106. For example, network 104 may form part a packet-based network, such as a local area network, a wide-area network, or a global network such as the Internet. Network 104 may include routers, switches, base stations, or any other equipment that may be useful to facilitate data between personal computing device 106 and servers 102.

Examples of servers 102 include server devices that provide functionality to personal computing device 106. For example, servers 102 may share data or resources for performing computations for personal computing device 106. As one example, servers 102 may be computing servers, but the example techniques are not so limited. Servers 102 may be a combination of computing servers, web servers, database servers, and the like.

Content creators for three-dimensional image content may utilize implicit rendering techniques described above. Such content creators may, for example, work in various fields such as commerce, video games, etc. For ease of illustration and example purposes only, one or more examples are described in the space of commerce, but the techniques described in this disclosure should not be considered limited.

For example, a company may generate three-dimensional image content of an object (e.g., a couch) that a user can view from all angles with personal computing device 106. In one or more examples, the company may utilize machine learning (e.g., deep learning) techniques to generate photorealistic three-dimensional image content. As an example, the company may generate two-dimensional images of the object (e.g., couch) from different viewing angles and different locations of the object (e.g., in front, behind, above, below, etc.). One or more servers 102 may then use the two-dimensional images to train a neural network. One example way in which to train the neural network is using the NeRF training techniques; however, other techniques are possible. The result of the training is trained model 108, also called trained neural network 108, as one example.

In one or more example, there may be multiple trained models 108 that are generated, and one of the trained models 108 may be selected based on various factors such as desired quality, etc. For ease, the example techniques is described with having one trained model 108, but the techniques should not be considered limited.

In such machine learning based three-dimensional image content generation, trained model 108 is set of continuous mathematical functions and equations that define the object from any viewing angle or position. That is, rather than explicit rendering techniques in which there is a mesh or some other form of physical model that defines the object, in implicit rendering techniques, trained model 108 defines the object.

For instance, the way three-dimensional image content is displayed has evolved over time. Three-dimensional content was represented via point clouds, then voxels, meshes etc. Mesh is currently the de-facto representation, finding application in games, three-dimensional movies, AR/VR etc.

As described, three-dimensional content may be represented via implicit functions, such as by trained model 108. The three-dimensional content is assumed to be a function, and one or more servers 102 try to learn this function with the help of various inductive biases. This is similar to learning functions in deep learning. In one or more examples, one or more server 102 approximate these functions with neural networks to generate trained model 108.

For a user to view the object, the user may execute an application on personal computing device 106. For instance, the user may execute mobile renderer 112. Examples of mobile renderer 112 includes a web browser, a gaming application, or an extended reality (e.g., virtual reality, augmented reality, or mixed reality) application. In some examples, mobile renderer 112 may be company specific application (e.g., an application generated by the company to allow the user to view couches made by the company). There may be other examples of mobile renderer 112, and the techniques described in this disclosure are not limited to the above examples.

In some cases, when three-dimensional space is interpreted as surfaces, the amount of space occupied may be very small. In some examples, inverse volumetric rendering three-dimensional reconstruction pipelines, the entire space is sampled. However, most of the computation done is of no use, leading to increased training time and wasted computation.

Inverse volumetric rendering may refer to recovering object and scene properties from image data. Examples of the object and scene properties may include geometry, reflectance, and illumination. In volumetric rendering, rays are utilized to determine where the rays intersect pixels, and utilizing the color and density (e.g., opacity) values for rendering.

That is, as described above, for training to generate trained model 108, the amount of time needed to generate trained model 108 may be based on the number of samples on a ray that are used as input. In this disclosure, one or more servers 102 may use point clouds to filter out samples on a ray that do not contribute to the training, while selectively keeping samples on the ray that do contribute to the training for generation of trained model 108.

In some examples, for inverse volumetric rendering pipeline, there may be a problem of shape radiance ambiguity. Shape radiance ambiguity may occur when different three-dimensional shapes can project the same image on a two-dimensional plane. For instance, this issue may be present in radiance from reflection or lighting, where trained model 108 may not be able to resolve between whether pixels are for an object or reflection of light or shining off of the object.

The example techniques described in this disclosure include one or more servers 102 utilizing point cloud data obtained in a pre-processing pipeline to guide the network training (e.g., training of neural network 108). In some examples, there may be 75% reduction in training time. The reduction of 75% is provided as an example, and should not be considered as a requirement in the reduction in training time. Also, the example techniques may result in removal of cloudy artifacts observed in implicit rendering techniques, such as NeRF, by solving for shaping radiance ambiguity.

In one or more examples, one or more servers 102 may translate/scale the scene in a way that the object of interest is bounded in a box centered at origin, ranging from [−n, n]. One or more servers 102 may create a sparse reconstruction of the scene.

One or more servers 102 may utilize the MVSNet based pipeline. MVSNet may be considered as a deep learning architecture for depth map inference from unstructured multi-view images. For any reference image, such models of deep learning architecture for depth map inference, such as MVSNet, may use nearby images as a source, and generate a depth map and confidence map. One or more servers 102 may generate these maps for all the images, such as the images used to train trained neural network 108.

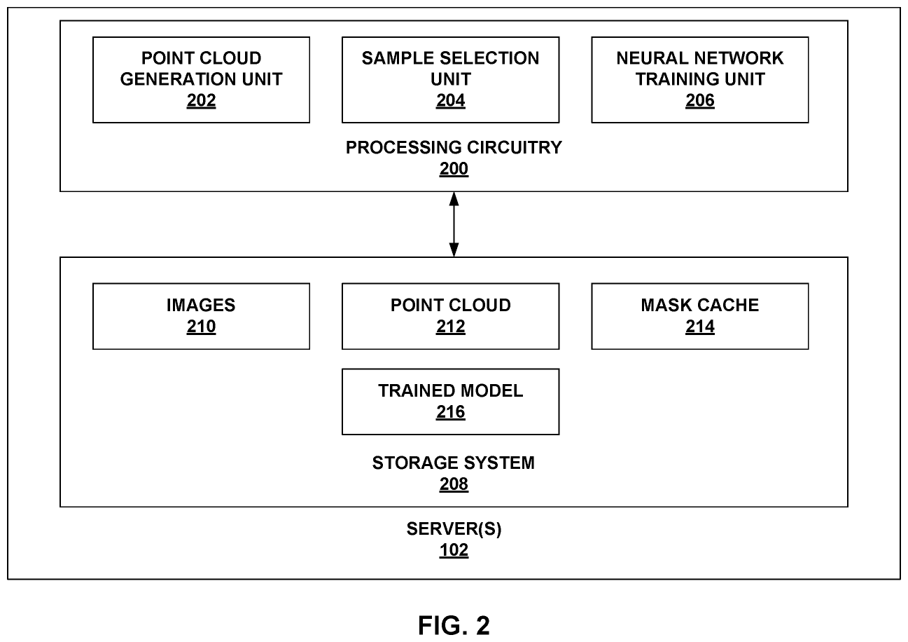

By default, these depth estimates may not be consistent. In order to obtain a consistent geometry, one or more servers 102 may project these depth maps in three-dimensional space and check for geometric consistency across nearby views. The output of this process (e.g., projection of depth maps in three-dimensional space) may be a point cloud which tends to be consistent and accurate. Some example techniques to generate the depth map are described with respect to FIG. 2 from which the point cloud can be determined.

In one or more examples, the point cloud may form the sparse intermediate reconstruction of geometry. One or more servers 102 may utilize this point cloud to constrain the sampling area in the inverse rendering pipeline.

For example, one or more servers 102 may partition the space inside the bounding box of the scene into a grid. The density of the grid may be one of the hyper-parameters. One or more servers 102 may convert this grid into an occupancy grid. For example, one or more servers 102 may check whether a point belongs inside a voxel or not. For sample points inside a voxel, there may be occupancy, and samples of a ray that intersect with the point may be used for training to generate trained model 108.

However, to perform such check in a naive way may be very time consuming as the number of points in the point cloud and the grid lies in ranges of tens of millions. In order to perform such checks in an efficient manner, one or more servers 102 may use fixed-radius nearest neighbor algorithm, which may be faster. For the fixed-radius nearest neighbor algorithm, the radius may be specified. As one example, the radius may set as half the diagonal length of each voxel.

The quality and density of the occupancy grid may rely heavily on the accuracy and density of the point cloud. While the quality and density of the occupancy grid may be acceptable for most cases, to further increase quality, one or more servers 102 may add a dilation factor to the radius. The addition of the dilation factor may assist with accounting for small gaps in the geometry that may have been missed in the point cloud.

In this way, one or more servers 102 may generate an occupancy grid. The occupancy grid may form the basis to deal with both the free space as well as shape radiance ambiguity.

The following describes examples of dealing with free space sampling/computing. In volumetric rendering, to render an image, multiple points are sampled on the ray. While these samples span from the near and far point of the scene, one or more servers 102 or possibly a graphics processing unit (GPU) on personal computing device 106 (e.g., as part of volumetric rendering) may restrain the sampling to occur only within occupied voxels, i.e., voxels where the occupancy grid is one. To do so, one or more servers 102 or personal computing device 106 may scale the points to the minimum and maximum coordinates of the occupancy grid and interpolate values using nearest neighbor interpolation. In this way, in some cases, it may be possible to eliminate more than 95% of sampling that would have otherwise happened in a naive linear sampling. The elimination of 95% of sampling is provided as an example, and should not be considered as a requirement. The example techniques may be applicable to almost all inverse volumetric rendering pipelines.

The following describes techniques for dealing with shape radiance ambiguity. Inverse rendering pipelines rely on the trained model to figure out a consistent shape. Generally, inverse rendering pipelines converge to solutions that are appropriately balance computational complexity. However, within the space of the solutions there are still multiple solutions. In order to overcome this limitation, NerfingMVS introduced guided optimization that allowed sampling only in regions where the geometry is most likely to be. In one or more examples described in this disclosure, the occupancy grid, generated using the example techniques, may allow emulating the same behavior and removing the shape radiance ambiguity.

In one or more examples, one or more servers 102 may execute trained model 108 to generate color values 110 of image content. One or more servers 102 may transmit color values 110 to personal computing device 106. In some examples, in addition to or instead of transmitting color values 110, one or more servers 102 may transmit trained model 108.

FIG. 2 is a block diagram illustrating one or more servers of FIG. 1 in greater detail. As illustrated, one or more servers 102 include processing circuitry 200 and storage system 208. Storage system 208 includes one or more memory units.

Processing circuitry 200 may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry. In general, processing circuitry 200 may be configured to perform one or more example techniques described in this disclosure via fixed-function circuits, programmable circuits, or a combination thereof. Fixed-function circuits refer to circuits that provide particular functionality and are preset on the operations that can be performed. Programmable circuits refer to circuits that can programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Processing circuitry 200 may include arithmetic logic units (ALUs), elementary function units (EFUs), digital circuits, analog circuits, and/or programmable cores, formed from programmable circuits. In examples where the operations of processing circuitry 200 are performed using software executed by the programmable circuits, storage system 208 may store the object code of the software that processing circuitry 200 receives and executes.

In the example of FIG. 2, processing circuitry 200 is illustrated as including point cloud generation unit 202, sample selection unit 204, and neural network training unit 206. Point cloud generation unit 202, sample selection unit 204, and neural network training unit 206 are illustrated as separate units for ease of illustration and description. In one or more examples, point cloud generation unit 202, sample selection unit 204, and neural network training unit 206 may be formed together, and may be software executing on processing circuitry 200.

Storage system 208 may store program modules and/or instructions and/or data that are accessible by processing circuitry 200. For example, storage system 208 may store images 210, point cloud 212, mask cache 214, and trained model 216. System memory 306 may additionally store information for use by and/or generated by other components of personal computing device 106. Storage system 208 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some examples, storage system 208 is non-transitory storage media. The term “non-transitory” indicates that the storage medium is not embodied in a carrier wave or a propagated signal. However, the term “non-transitory” should not be interpreted to mean that memory units of storage system 208 are non-movable or that its contents are static. As one example, memory units of storage system 208 may be removed from servers 102, and moved to another device. As another example, memory units, substantially similar to memory units of storage system 208, may be inserted into servers 102. In certain examples, non-transitory storage media may store data that can, over time, change (e.g., in RAM).

Images 210 may be a plurality of images from a plurality of respective viewpoints in a scene. Images 210 may be two-dimensional images, and for each viewpoint in a set of viewpoints, there may be corresponding image of images 210. Images 210 may sparsely represent a three-dimensional scene. That is, images from all viewpoints of the three-dimensional scene may not be available. However, using machine learning techniques, such as NeRF, it may be possible to generate image content from any viewpoint of the scene.

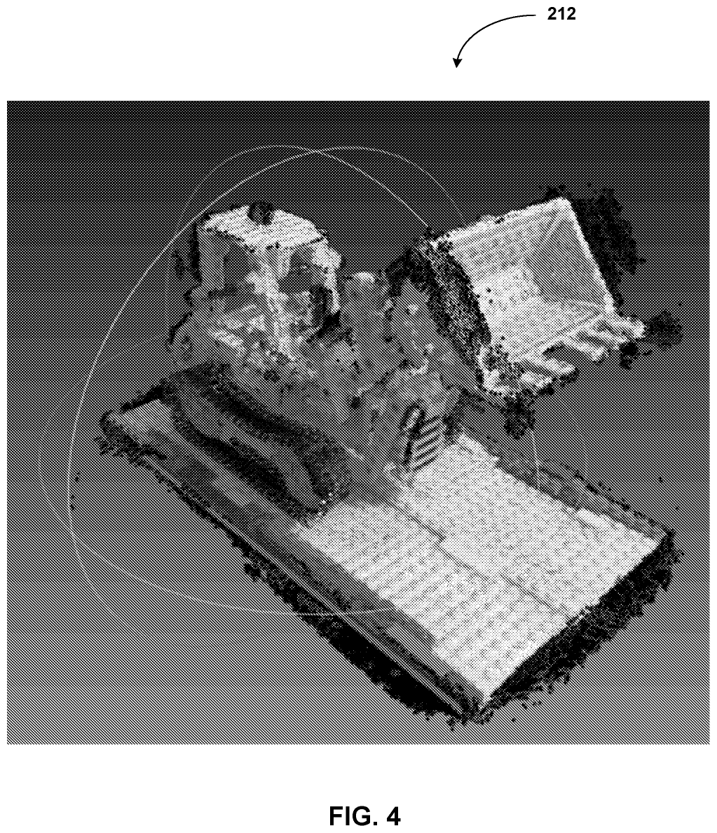

In one or more examples, point cloud generation unit 202 may generate point cloud 212 based on the plurality of images 210. An example of point cloud 212 is illustrated in FIG. 4, where FIG. 4 is a conceptual diagram of a point cloud. For instance, point cloud 212, as shown in FIG. 4, is a discrete set of points in space that represent a three-dimensional shape.

In some examples, point cloud generation unit 202 may generate point cloud with a MVSNet based pipeline, and depth maps from the MVSNet based pipeline. As one example, to generate point cloud 212, point cloud generation unit 202 may be configured to generate a two-dimensional depth map based on the plurality of images 210, and generate the point cloud 212 based on the two-dimensional depth map. For example, for each of images 210 there may be associated pose information that is stored in storage system 208. The pose information may be indicative of the position in three-dimensional space and the direction in the three-dimensional space of images 210. Point cloud generation unit 202 may use the pose information to generate the depth map.

For instance, assume that the two-dimensional depth map is a first two-dimensional depth map. To generate the point cloud 212, point cloud generation unit 202 may be configured to construct a three-dimensional representation based on the first two-dimensional depth map. For instance, the depth map may indicate relative depths of images 210 (e.g., based on pose information) and pixels in images 210. Therefore, point cloud generation unit 202 may determine where images 210 are located relative to one another in three-dimensional space to construct the three-dimensional representation.

Point cloud generation unit 202 may generate a second two-dimensional depth map based on the three-dimensional representation (e.g., by unprojecting the three-dimensional representation back to a depth map). For instance, the three-dimensional representation may be a plurality of voxels in three-dimensional space. Point cloud generation unit 202 may evaluate voxels in the three-dimensional representation to determine depth of each of the voxels.

In one or more example, point cloud generation unit 202 may determine whether corresponding samples are located at different locations in the first two-dimensional depth map and the second two-dimensional depth map. For instance, the first two-dimensional depth map (e.g., from pose information of images 210) and the second two-dimensional depth map (e.g., from unprojecting the three-dimensional representation) should be the same. However, due to inconsistency in the depth map generation by point cloud generation unit 202, the depth of the same pixel in the first and second depth maps may end up being different.

Point cloud generation unit 202 may generate the point cloud 212 based on the determination of whether corresponding samples are located at different locations in the first two-dimensional depth map and the second two-dimensional depth map. For instance, point cloud generation unit 202 may shift or modify location of pixels with different depths in the first and second depth maps to correct for any inconsistencies when generating point cloud 212. There may be other ways in which to generate point cloud 212, and the example techniques are not limited the examples provided in this disclosure.

Sample selection unit 204 may be configured to determine samples on a ray from a viewpoint of the plurality of viewpoints based on the point cloud 212. For instance, sample selection unit 204 may extend a ray from a viewpoint towards one of images 210 associated with a viewpoint of the plurality of viewpoints, and determine which samples on that ray are to be input into neural network training unit 206 for generating trained model 216.

As one example, to determine samples on the ray from the viewpoint of the plurality of viewpoints based on the point cloud 212, sample selection unit 204 may be configured to determine one or more bounding boxes that bound one or more objects in the scene, and generate a grid of points of the point cloud 212 within the one or more bounding boxes. For example, the bounding boxes may be three-dimensional bounding boxes that encompass the one or more objects.

Sample selection unit 204 may determine voxels in the grid that are proximate an edge of the one or more bounding boxes or the point cloud 212. For instance, sample selection unit 204 may use a fixed-radius nearest neighboring algorithm, or some other technique, to determine voxels in the grid that are near or at an edge of the one or more bounding boxes. In some examples, sample selection unit 204 may use a fixed-radius nearest neighboring algorithm, or some other technique, to determine voxels in the grid that are near or at an edge of the point cloud 212.

Sample selection unit 204 may assign the determined voxels a value indicating whether the ray intersects the determined voxels. For instance, the value indicating whether the ray intersects the determined voxels may be considered as an occupancy grid that indicates whether the voxel is on or near a point in point cloud 212 and intersects the ray of the viewpoint.

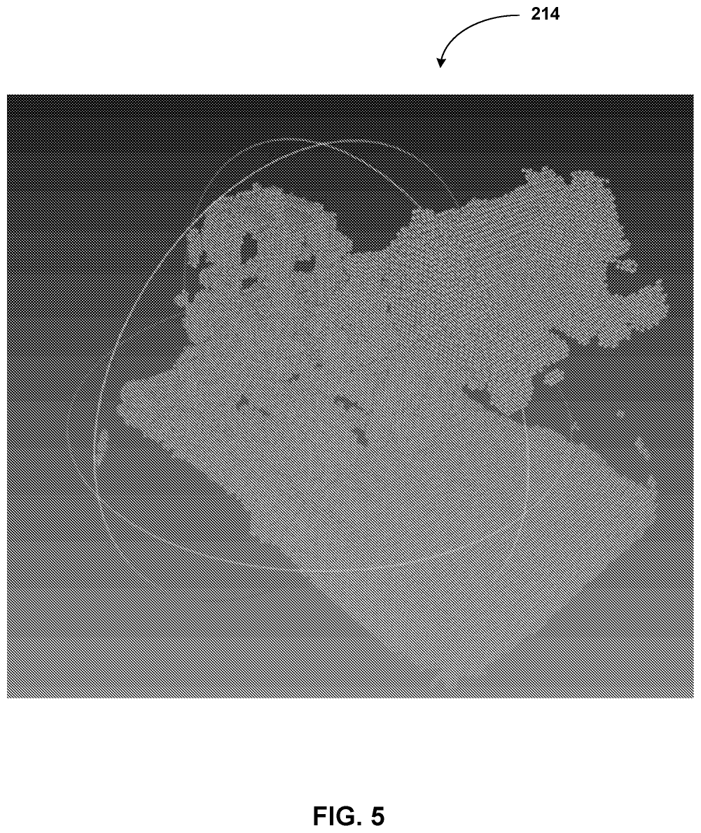

Mask cache 214 is an example of the occupancy grid indicates whether the voxel is on or near a point in point cloud 212 and intersects the ray of the viewpoint. For instance, FIG. 5 is a conceptual diagram of a mask cache 214 indicative of occupancy of a voxel in a grid. For instance, the colored dots in FIG. 5 represent voxels with an occupancy value of 1 (e.g., there is intersection with one or more objects).

Sample selection unit 204 may determine the samples on the ray based on the assigned values. For instance, sample selection unit 204 may access mask cache 214 to determine which voxels have an occupancy value of 1 for a given ray, and input samples (e.g., pose information for the samples) that correspond to those voxels having an occupancy value of 1 for that given ray as input into neural network training unit 206.

Neural network training unit 206 may be configured to train a neural network based on the determined samples on the ray to generate a trained model 216. The trained model 216 may be configured to generate image content of the scene from a viewpoint different than the plurality of viewpoints (e.g., from a viewpoint for which there is not one of images 210). For instance, processing circuitry 200 may receive a request to generate image content for the scene from a second viewpoint other than the plurality of viewpoints. For instance, personal computing device 106 may transmit the request. That is, there may be no one of images 210 that provides all of the image content from the second viewpoint of the scene.

As described, processing circuitry 200 may perform volumetric rendering to generation image content for the second viewpoint. For instance, processing circuitry 200 may input position information of samples along a second ray (e.g., not necessarily a ray used for training) from the second viewpoint into the trained model 216 to generate the requested image content. Processing circuitry 200 may output the requested image content (e.g., via network 104) to personal computing device 106. In one or more examples, the requested image content may be the color values 110 of FIG. 1.

For example, the trained model 216 may be a volumetric scene function for directly generating an appearance of the scene. In this example, for samples along the second ray (e.g., for volumetric rendering), trained model 216 may determine whether the sample is inside or outside the one or more objects of the scene and a color and density for the sample, and integrate over the samples to determine color for that second ray. Processing circuitry 200 may repeat such operations for different rays to generate the image content for the second viewpoint (e.g., color values 110 of FIG. 1).

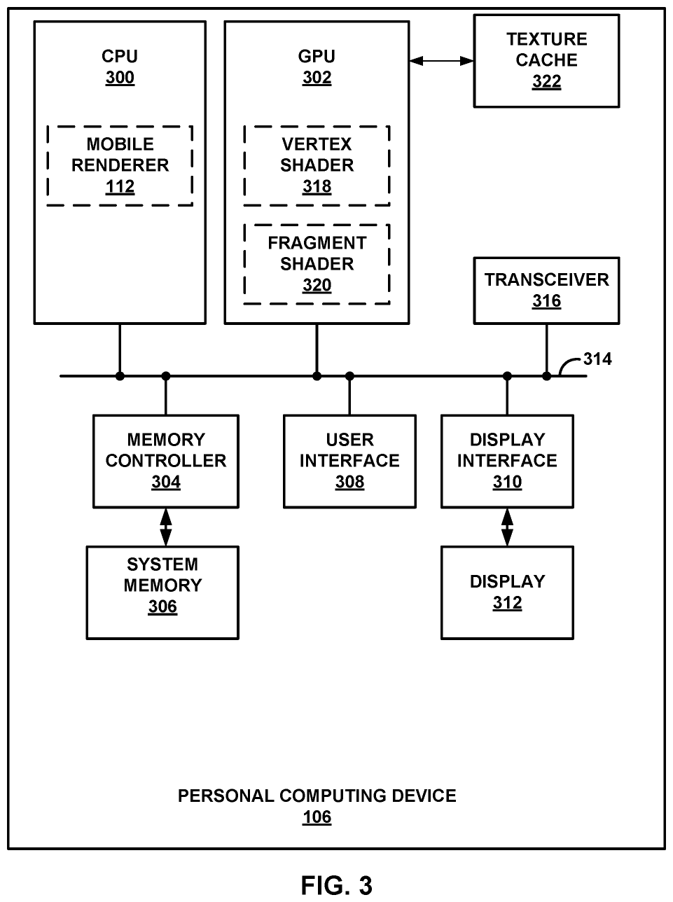

FIG. 3 is a block diagram illustrating an example of a personal computing device configured to perform one or more example techniques described in this disclosure. Examples of personal computing device 106 include a computer (e.g., personal computer, a desktop computer, or a laptop computer), a mobile device such as a tablet computer, a wireless communication device (such as, e.g., a mobile telephone, a cellular telephone, a satellite telephone, and/or a mobile telephone handset), a landline telephone, an Internet telephone, a handheld device such as a portable video game device or a personal digital assistant (PDA). Additional examples of personal computing device 106 include a personal music player, a video player, a display device, a camera, a television, or any other type of device that processes and/or displays graphical data.

As illustrated in the example of FIG. 3, personal computing device 106 includes a central processing unit (CPU) 300, a GPU 302, memory controller 304 that provides access to system memory 306, user interface 308, and display interface 310 that outputs signals that cause graphical data to be displayed on display 312. Personal computing device 106 also includes transceiver 316, which may include wired or wireless communication links, to communicate with network 104 of FIG. 1.

Also, although the various components are illustrated as separate components, in some examples the components may be combined to form a system on chip (SoC). As an example, CPU 300, GPU 302, and display interface 310 may be formed on a common integrated circuit (IC) chip. In some examples, one or more of CPU 300, GPU 302, and display interface 310 may be in separate IC chips. Various other permutations and combinations are possible, and the techniques should not be considered limited to the example illustrated in FIG. 3. The various components illustrated in FIG. 3 (whether formed on one device or different devices) may be formed as at least one of fixed-function or programmable circuitry such as in one or more microprocessors, ASICs, FPGAs, DSPs, or other equivalent integrated or discrete logic circuitry.

This disclosure describes example techniques being performed by processing circuitry. Examples of the processing circuitry includes any one or combination of CPU 300, GPU 302, and display interface 310. For explanation, the disclosure describes certain operations being performed by CPU 300, GPU 302, and display interface 310. Such example operations being performed by CPU 300, GPU 302, and/or display interface 310 are described for example purposes only, and should not be considered limiting.

The various units illustrated in FIG. 3 communicate with each other using bus 314. Bus 314 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXtensible Interface (AXI) bus) or another type of bus or device interconnect. It should be noted that the specific configuration of buses and communication interfaces between the different components shown in FIG. 3 is merely exemplary, and other configurations of computing devices and/or other image processing systems with the same or different components may be used to implement the techniques of this disclosure.

CPU 300 may be a general-purpose or a special-purpose processor that controls operation of personal computing device 106. A user may provide input to personal computing device 106 to cause CPU 300 to execute one or more software applications. The software applications that execute on CPU 300 may include, for example, mobile renderer 112. However, in other applications, GPU 302 or other processing circuitry may be configured to execute mobile renderer 112. A user may provide input to personal computing device 106 via one or more input devices (not shown) such as a keyboard, a mouse, a microphone, touchscreen, a touch pad or another input device that is coupled to personal computing device 106 via user interface 308. In some examples, such as where personal computing device 106 is a mobile device (e.g., smartphone or tablet), user interface 308 may be part of display 312.

GPU 302 may be configured to implement a graphics pipeline that includes programmable circuitry and fixed-function circuitry. GPU 302 is an example of processing circuitry configured to perform one or more example techniques described in this disclosure. In general, GPU 302 (e.g., which is an example processing circuitry) may be configured to perform one or more example techniques described in this disclosure via fixed-function circuits, programmable circuits, or a combination thereof. Fixed-function circuits refer to circuits that provide particular functionality and are preset on the operations that can be performed. Programmable circuits refer to circuits that can programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

GPU 302 may include arithmetic logic units (ALUs), elementary function units (EFUs), digital circuits, analog circuits, and/or programmable cores, formed from programmable circuits. In examples where the operations of GPU 302 are performed using software executed by the programmable circuits, memory 306 may store the object code of the software that GPU 302 receives and executes.

Display 312 may include a monitor, a television, a projection device, a liquid crystal display (LCD), a plasma display panel, a light emitting diode (LED) array, electronic paper, a surface-conduction electron-emitted display (SED), a laser television display, a nanocrystal display or another type of display unit. Display 312 may be integrated within personal computing device 106. For instance, display 312 may be a screen of a mobile telephone handset or a tablet computer. Alternatively, display 312 may be a stand-alone device coupled to personal computing device 106 via a wired or wireless communications link. For instance, display 312 may be a computer monitor or flat panel display connected to a personal computer via a cable or wireless link.

CPU 300 and GPU 302 may store image data, and the like in respective buffers that are allocated within system memory 306. In some examples, GPU 302 may include dedicated memory, such as texture cache 322. Texture cache 322 may be embedded on GPU 302, and may be a high bandwidth low latency memory. Texture cache 322 is one example of memory of GPU 302, and there may be other examples of memory for GPU 302. For example, the memory for GPU 302 may be used to store textures, mesh definitions, framebuffers and constants in graphics mode. The memory for GPU 302 may be split into two main parts: the global linear memory and texture cache 322. Texture cache 322 may be dedicated to the storage of two-dimensional or three-dimensional textures. A texture in graphics processing may refer to image content that rendered on to an object geometry.

Texture cache 322 may be spatially close to GPU 302. In some examples, texture cache 322 is accessed through texture samplers that are special dedicated hardware providing very fast linear interpolations.

System memory 306 may also store information. In some examples, due to the limited size of texture cache 322, GPU 302 and/or CPU 26 may determine whether the desired information is stored in texture cache 322 first. If the information is not stored in texture cache 322, CPU 26 and/or GPU 302 may retrieve the information for storage in texture cache 322.

Memory controller 304 facilitates the transfer of data going into and out of system memory 306. For example, memory controller 304 may receive memory read and write commands, and service such commands with respect to memory 306 in order to provide memory services for the components in personal computing device 106. Memory controller 304 is communicatively coupled to system memory 306. Although memory controller 304 is illustrated in the example of personal computing device 106 of FIG. 3 as being a processing circuit that is separate from both CPU 300 and system memory 306, in other examples, some or all of the functionality of memory controller 304 may be implemented on one or both of CPU 300 and system memory 306.

System memory 306 may store program modules and/or instructions and/or data that are accessible by CPU 300 and GPU 302. For example, system memory 306 may store user applications (e.g., object code for mobile renderer 112), rendered image content from GPU 302, etc. System memory 306 may additionally store information for use by and/or generated by other components of personal computing device 106. System memory 306 may include one or more volatile or non-volatile memories or storage devices, such as, for example, RAM, SRAM, DRAM, ROM, EPROM, EEPROM, flash memory, a magnetic data media or an optical storage media.

In some aspects, system memory 306 may include instructions that cause CPU 300, GPU 302, and display interface 310 to perform the functions ascribed to these components in this disclosure. Accordingly, system memory 306 may be a computer-readable storage medium having instructions stored thereon that, when executed, cause one or more processors (e.g., CPU 300, GPU 302, and display interface 310) to perform various functions.

In some examples, system memory 306 is a non-transitory storage medium. The term “non-transitory” indicates that the storage medium is not embodied in a carrier wave or a propagated signal. However, the term “non-transitory” should not be interpreted to mean that system memory 306 is non-movable or that its contents are static. As one example, system memory 306 may be removed from personal computing device 106, and moved to another device. As another example, memory, substantially similar to system memory 306, may be inserted into personal computing device 106. In certain examples, a non-transitory storage medium may store data that can, over time, change (e.g., in RAM).

Display interface 310 may retrieve the data from system memory 306 and configure display 312 to display the image represented by the generated image data. In some examples, display interface 310 may include a digital-to-analog converter (DAC) that is configured to convert the digital values retrieved from system memory 306 into an analog signal consumable by display 312. In other examples, display interface 310 may pass the digital values directly to display 312 for processing.

One or more servers 102 may compress and transmit color values 110 and, in some examples, trained neural network 108 (e.g., code for trained neural network 108). Transceiver 316 may receive the information, and a decoder (not shown) may reconstruct color values 110 and/or trained neural network 108. In one or more examples, texture cache 322 may store some or all of color values 110.

In some examples, CPU 300 and GPU 302 may together render the image content of the object for display on display 312 (e.g., such as using color values 110 and/or trained neural network 108). For instance, as illustrated and described above, CPU 300 may execute mobile renderer 112, which may be the application for which the image content of the object is being rendered. GPU 302 may be configured to execute vertex shader 318 and fragment shader 320 to actually render the image content of the object. As mobile renderer 112 is executing on CPU 300, mobile renderer 112 may cause CPU 300 to instruct GPU 302 to execute vertex shader 318 and fragment shader 320, as needed. Mobile renderer 112 may generate instructions or data that are fed to vertex shader 318 and fragment shader 320 for rendering. Vertex shader 318 and fragment shader 320 may execute on the programmable circuitry of GPU 302, and other operations of the graphics pipeline may be performed on the fixed-function circuitry of GPU 302.

Vertex shader 318 may be configured to transform data from a world coordinate system of the user given by an operating system or mobile renderer 112 into a special coordinate system known as clip space. For instance, the user may be located at a particular location, and the location of the user may be defined in world coordinate system. However, where the image content is to be rendered so that the image content is rendered at the correct perspective, such as size and location, may be based on clip space.

Vertex shader 318 may be configured to determine a ray origin, a direction, and near and far values for hypothetical rays in a three-dimensional space that is defined by the voxel grid. Fragment shader 320 may access texture cache 322 to determine the color and density values along the hypothetical rays in the three-dimensional space.

In some examples, mobile renderer 112 may be configured to output the commands to vertex shader 318 and/or fragment shader 320. The commands may conform to a graphics application programming interface (API), such as, e.g., an Open Graphics Library (OpenGL®) API, OpenGL® 3.3, an Open Graphics Library Embedded Systems (OpenGL ES) API, an OpenCL API, a Direct3D API, an X3D API, a RenderMan API, a WebGL API, or any other public or proprietary standard graphics API. The techniques should not be considered limited to requiring a particular API.

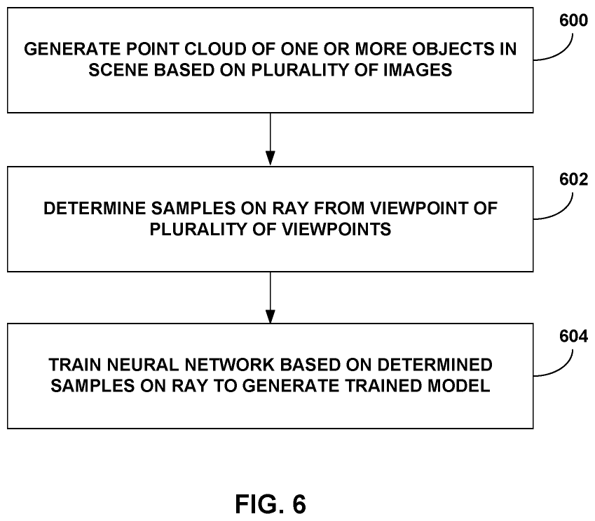

FIG. 6 is a flowchart illustrating an example method of training a neural network for Neural Radiance Field (NeRF). For ease, the example of FIG. 6 is described with respect to FIG. 2.

Point cloud generation unit 202 may be configured to generate a point cloud 212 of a scene based on a plurality of images 210 that are from a plurality of viewpoints in a scene (600). To generate the point cloud 212, point cloud generation unit 202 may be configured to generate the point cloud 212 for one or more objects in the scene. One example of point cloud 212 is illustrated in FIG. 4. There may be various ways in which to generate point cloud 212, and the example techniques should not be considered limited to a specific point cloud generation technique.

Sample selection unit 204 may determine samples on a ray from a viewpoint of the plurality of viewpoints based on the point cloud 212 (602). For example, sample selection unit 204 may determine one or more bounding boxes that bound one or more objects in the scene, and generate a grid of points of the point cloud 212 within the one or more bounding boxes. Sample selection unit 204 may determine voxels in the grid that are proximate an edge of the one or more bounding boxes or the point cloud 212. Sample selection unit 204 may assign the determined voxels a value indicating whether the ray intersects the determined voxels. For instance, sample selection unit 204 may generate mask cache 214 that indicates whether the ray interests the determined voxel for a given ray, and one example of mask cache 214 is illustrated in FIG. 5. Sample selection unit 204 may determine the samples on the ray based on the assigned values (e.g., based on mask cache 214).

Neural network training unit 206 may train a neural network based on the determined samples on the ray to generate a trained model 216 (604). The trained model 216 being configured to generate image content of the scene from a viewpoint different than the plurality of viewpoints. In some examples, trained model 216 is a NeRF trained model, and may provide a volumetric scene function for directly generating an appearance of the scene.

To train the neural network, neural network training unit 206 may be configured to input the samples from the ray (e.g., as determined by sample selection unit 204) to the neural network. Neural network training unit 206 may apply weights and biases of the neural network to the samples to generate a two-dimensional representation of the scene from the viewpoint, and compare the two-dimensional representation to an image of the plurality of viewpoints. Neural network training unit 206 may update the weights or biases of the neural network based on the comparison to generate the trained model 216.

The disclosure describes various examples, such as the following, that may be implemented together or in combination.

Example 1. A system comprising: a storage system configured to store a plurality of images from a plurality of viewpoints in a scene; processing circuitry coupled to the storage system and configured to: generate a point cloud of the scene based on the plurality of images; determine samples on a ray from a viewpoint of the plurality of viewpoints based on the point cloud; and train a neural network based on the determined samples on the ray to generate a trained model, the trained model being configured to generate image content of the scene from a viewpoint different than the plurality of viewpoints.

Example 2. The system of example 1, wherein to generate the point cloud, the processing circuitry is configured to generate the point cloud for one or more objects in the scene, and wherein the trained model is configured to generate image content of the one or more objects in the scene.

Example 3. The system of any of examples 1 and 2, wherein the trained model is a neural radiance fields (NeRF) trained model.

Example 4. The system of any of examples 1-3, wherein to train the neural network, the processing circuitry is configured to: input the samples from the ray to the neural network; apply weights and biases of the neural network to the samples to generate a two-dimensional representation of the scene from the viewpoint; compare the two-dimensional representation to an image of the plurality of viewpoints; and update the weights or biases of the neural network based on the comparison to generate the trained model.

Example 5. The system of any of examples 1-4, wherein to determine samples on the ray from the viewpoint of the plurality of viewpoints based on the point cloud, the processing circuitry is configured to: determine one or more bounding boxes that bound one or more objects in the scene; generate a grid of points of the point cloud within the one or more bounding boxes; determine voxels in the grid that are proximate an edge of the one or more bounding boxes or the point cloud; assign the determined voxels a value indicating whether the ray intersects the determined voxels; and determine the samples on the ray based on the assigned values.

Example 6. The system of any of examples 1-5, wherein to generate the point cloud, the processing circuitry is configured to: generate a two-dimensional depth map based on the plurality of images; and generate the point cloud based on the two-dimensional depth map.

Example 7. The system of example 6, wherein the two-dimensional depth map is a first two-dimensional depth map, and wherein to generate the point cloud, the processing circuitry is configured to: construct a three-dimensional representation based on the first two-dimensional depth map; generate a second two-dimensional depth map based on the three-dimensional representation; determine whether corresponding samples are located at different locations in the first two-dimensional depth map and the second two-dimensional depth map; and generate the point cloud based on the determination of whether corresponding samples are located at different locations in the first two-dimensional depth map and the second two-dimensional depth map.

Example 8. The system of any of examples 1-7, wherein the trained model comprise a volumetric scene function for directly generating an appearance of the scene.

Example 9. The system of any of examples 1-8, wherein the viewpoint is a first viewpoint, wherein the ray is a first ray, and wherein the processing circuitry is configured to: receive a request to generate image content for the scene from a second viewpoint other than the plurality of viewpoints; input position information of samples along a second ray from the second viewpoint into the trained model to generate the requested image content; and output the requested image content.

Example 10. A method comprising: generating a point cloud of a scene based on a plurality of images from a plurality of viewpoints in the scene; determining samples on a ray from a viewpoint of the plurality of viewpoints based on the point cloud; and training a neural network based on the determined samples on the ray to generate a trained model, the trained model being configured to generate image content of the scene from a viewpoint different than the plurality of viewpoints.

Example 11. The method of example 10, wherein generating the point cloud comprises generating the point cloud for one or more objects in the scene, and wherein the trained model is configured to generate image content of the one or more objects in the scene.

Example 12. The method of any of examples 10 and 11, wherein the trained model is a neural radiance fields (NeRF) trained model.

Example 13. The method of any of examples 10-12, wherein training the neural network comprises: inputting the samples from the ray to the neural network; applying weights and biases of the neural network to the samples to generate a two-dimensional representation of the scene from the viewpoint; comparing the two-dimensional representation to an image of the plurality of viewpoints; and updating the weights or biases of the neural network based on the comparison to generate the trained model.

Example 14. The method of any of examples 10-13, wherein determining samples on the ray from the viewpoint of the plurality of viewpoints based on the point cloud comprises: determining one or more bounding boxes that bound one or more objects in the scene; generating a grid of points of the point cloud within the one or more bounding boxes; determining voxels in the grid that are proximate an edge of the one or more bounding boxes or the point cloud; assigning the determined voxels a value indicating whether the ray intersects the determined voxels; and determining the samples on the ray based on the assigned values.

Example 15. The method of any of examples 10-14, wherein generating the point cloud comprises: generating a two-dimensional depth map based on the plurality of images; and generating the point cloud based on the two-dimensional depth map.

Example 16. The method of example 15, wherein the two-dimensional depth map is a first two-dimensional depth map, and wherein generating the point cloud comprises: constructing a three-dimensional representation based on the first two-dimensional depth map; generating a second two-dimensional depth map based on the three-dimensional representation; determining whether corresponding samples are located at different locations in the first two-dimensional depth map and the second two-dimensional depth map; and generating the point cloud based on the determination of whether corresponding samples are located at different locations in the first two-dimensional depth map and the second two-dimensional depth map.

Example 17. The method of any of examples 10-16, wherein the trained model comprise a volumetric scene function for directly generating an appearance of the scene.

Example 18. The method of any of examples 10-17, wherein the viewpoint is a first viewpoint, wherein the ray is a first ray, the method further comprising: receiving a request to generate image content for the scene from a second viewpoint other than the plurality of viewpoints; inputting position information of samples along a second ray from the second viewpoint into the trained model to generate the requested image content; and outputting the requested image content.

Example 19. Computer-readable storage media comprising instructions that when executed by one or more processors cause the one or more processors to: generate a point cloud of a scene based on a plurality of images from a plurality of viewpoints in the scene; determine samples on a ray from a viewpoint of the plurality of viewpoints based on the point cloud; and train a neural network based on the determined samples on the ray to generate a trained model, the trained model being configured to generate image content of the scene from a viewpoint different than the plurality of viewpoints.

Example 20. The computer-readable storage media of example 19, wherein the trained model is a neural radiance fields (NeRF) trained model.

The techniques of this disclosure may be implemented in a wide variety of computing devices. Any of the described units, modules or components may be implemented together or separately as discrete but interoperable logic devices. Depiction of different features as applications or units is intended to highlight different functional aspects and does not necessarily imply that such applications or units must be realized by separate hardware or software components. Rather, functionality associated with one or more applications or units may be performed by separate hardware or software components, or integrated within common or separate hardware or software components.

The techniques described in this disclosure may be implemented, at least in part, in hardware, software, firmware or any combination thereof. For example, various aspects of the techniques may be implemented within one or more microprocessors, DSPs, ASICs, FPGAs, or any other equivalent integrated or discrete logic circuitry. The terms “processor,” “processing circuitry,” “controller” or “control module” may generally refer to any of the foregoing logic circuitry, alone or in combination with other logic circuitry, or any other equivalent circuitry, and alone or in combination with other digital or analog circuitry.

For aspects implemented in software, at least some of the functionality ascribed to the systems and devices described in this disclosure may be embodied as instructions on a computer-readable storage medium such as RAM, ROM, non-volatile random access memory (NVRAM), EEPROM, FLASH memory, magnetic media, optical media, or the like that is tangible. The computer-readable storage media may be referred to as non-transitory. A server, client computing device, or any other computing device may also contain a more portable removable memory type to enable easy data transfer or offline data analysis. The instructions may be executed to support one or more aspects of the functionality described in this disclosure.

In some examples, a computer-readable storage medium comprises non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the devices, systems, and methods in accordance with the description provided in this disclosure are provided below.

What is claimed is:

1. A system comprising:
a storage system configured to store a plurality of images from a plurality of viewpoints in a scene; and
processing circuitry coupled to the storage system and configured to:
generate a point cloud of the scene based on the plurality of images;
determine samples on a ray from a viewpoint of the plurality of viewpoints based on the point cloud; and
train a neural network based on the determined samples on the ray to generate a trained model, the trained model being configured to generate image content of the scene from a viewpoint different than the plurality of viewpoints.

2. The system of claim 1, wherein to generate the point cloud, the processing circuitry is configured to generate the point cloud for one or more objects in the scene, and wherein the trained model is configured to generate image content of the one or more objects in the scene.

3. The system of claim 1, wherein the trained model is a neural radiance fields (NeRF) trained model.

4. The system of claim 1, wherein to train the neural network, the processing circuitry is configured to:
input the samples from the ray to the neural network;
apply weights and biases of the neural network to the samples to generate a two-dimensional representation of the scene from the viewpoint;
compare the two-dimensional representation to an image of the plurality of viewpoints; and
update the weights or biases of the neural network based on the comparison to generate the trained model.

5. The system of claim 1, wherein to determine samples on the ray from the viewpoint of the plurality of viewpoints based on the point cloud, the processing circuitry is configured to:
determine one or more bounding boxes that bound one or more objects in the scene;
generate a grid of points of the point cloud within the one or more bounding boxes;
determine voxels in the grid that are proximate an edge of the one or more bounding boxes or the point cloud;
assign the determined voxels a value indicating whether the ray intersects the determined voxels; and
determine the samples on the ray based on the assigned values.

6. The system of claim 1, wherein to generate the point cloud, the processing circuitry is configured to:
generate a two-dimensional depth map based on the plurality of images; and
generate the point cloud based on the two-dimensional depth map.

7. The system of claim 6, wherein the two-dimensional depth map is a first two-dimensional depth map, and wherein to generate the point cloud, the processing circuitry is configured to:
construct a three-dimensional representation based on the first two-dimensional depth map;
generate a second two-dimensional depth map based on the three-dimensional representation;
determine whether corresponding samples are located at different locations in the first two-dimensional depth map and the second two-dimensional depth map; and
generate the point cloud based on the determination of whether corresponding samples are located at different locations in the first two-dimensional depth map and the second two-dimensional depth map.

8. The system of claim 1, wherein the trained model comprise a volumetric scene function for directly generating an appearance of the scene.

9. The system of claim 1, wherein the viewpoint is a first viewpoint, wherein the ray is a first ray, and wherein the processing circuitry is configured to:
receive a request to generate image content for the scene from a second viewpoint other than the plurality of viewpoints;
input position information of samples along a second ray from the second viewpoint into the trained model to generate the requested image content; and
output the requested image content.

10. A method comprising:
generating a point cloud of a scene based on a plurality of images from a plurality of viewpoints in the scene;
determining samples on a ray from a viewpoint of the plurality of viewpoints based on the point cloud; and
training a neural network based on the determined samples on the ray to generate a trained model, the trained model being configured to generate image content of the scene from a viewpoint different than the plurality of viewpoints.

11. The method of claim 10, wherein generating the point cloud comprises generating the point cloud for one or more objects in the scene, and wherein the trained model is configured to generate image content of the one or more objects in the scene.

12. The method of claim 10, wherein the trained model is a neural radiance fields (NeRF) trained model.

13. The method of claim 10, wherein training the neural network comprises:
inputting the samples from the ray to the neural network;
applying weights and biases of the neural network to the samples to generate a two-dimensional representation of the scene from the viewpoint;
comparing the two-dimensional representation to an image of the plurality of viewpoints; and
updating the weights or biases of the neural network based on the comparison to generate the trained model.

14. The method of claim 10, wherein determining samples on the ray from the viewpoint of the plurality of viewpoints based on the point cloud comprises:
determining one or more bounding boxes that bound one or more objects in the scene;
generating a grid of points of the point cloud within the one or more bounding boxes;
determining voxels in the grid that are proximate an edge of the one or more bounding boxes or the point cloud;
assigning the determined voxels a value indicating whether the ray intersects the determined voxels; and
determining the samples on the ray based on the assigned values.

15. The method of claim 10, wherein generating the point cloud comprises:
generating a two-dimensional depth map based on the plurality of images; and
generating the point cloud based on the two-dimensional depth map.

16. The method of claim 15, wherein the two-dimensional depth map is a first two-dimensional depth map, and wherein generating the point cloud comprises:
constructing a three-dimensional representation based on the first two-dimensional depth map;
generating a second two-dimensional depth map based on the three-dimensional representation;
determining whether corresponding samples are located at different locations in the first two-dimensional depth map and the second two-dimensional depth map; and
generating the point cloud based on the determination of whether corresponding samples are located at different locations in the first two-dimensional depth map and the second two-dimensional depth map.

17. The method of claim 10, wherein the trained model comprise a volumetric scene function for directly generating an appearance of the scene.

18. The method of claim 10, wherein the viewpoint is a first viewpoint, wherein the ray is a first ray, the method further comprising:
receiving a request to generate image content for the scene from a second viewpoint other than the plurality of viewpoints;
inputting position information of samples along a second ray from the second viewpoint into the trained model to generate the requested image content; and
outputting the requested image content.

19. Computer-readable storage media comprising instructions that when executed by one or more processors cause the one or more processors to:
generate a point cloud of a scene based on a plurality of images from a plurality of viewpoints in the scene;
determine samples on a ray from a viewpoint of the plurality of viewpoints based on the point cloud; and
train a neural network based on the determined samples on the ray to generate a trained model, the trained model being configured to generate image content of the scene from a viewpoint different than the plurality of viewpoints.

20. The computer-readable storage media of claim 19, wherein the trained model is a neural radiance fields (NeRF) trained model.
